(19) United States
(12) Patent Application Publication
(10) Pub. No.: US 2009/0084229 A1
(43) Pub. Date: Apr. 2, 2009

(54) Programmable threaded insert installation tool and method of use

(76) Inventor: Ramon C. Villanueva, Palmdalo, CA (US)

Correspondence Address: KLEIN, DENATALE, GOLDNER, COOPER et. al., P.O. BOX 11172, BAKERSFIELD, CA, 93389-1172, US

(21) Appl. No.: 12/286,923

(22) Filed: Oct. 2, 2008

Related U.S. Application Data
(60) Provisional application No. 60/997,455, filed on Oct. 2, 2007.

(51) Int. Cl. B25B 13/48

(52) U.S. Cl. 81/180.1

(57) ABSTRACT

An system for installing an anchor device in an aperture in a workpiece having a first and a second side, where the second side is the blind side. The anchor device is the type in which a portion of the anchor device plastically deforms on the second side of the workpiece upon application of force to the anchor device. The installation system comprises a tool body comprising a front end section and a rotation means housing at a rearward portion of the tool body, wherein the front end section comprises a nose piece, and the rotation means housing comprises a rotation means having a drive shaft extending axially from the rotation means housing. There is an anchor device attachment means extending from the nose piece and a processing means adapted to transmit and receive electrical signals from the rotation means monitors the installation process. A user controlled activation means activates the rotation means and the processing means.

### CROSS-REFERENCE TO RELATED APPLICATIONS

U.S. Provisional Application No. 60/997,455 for this invention was filed on Oct. 2, 2007, for which application this inventor claims domestic priority.

### BACKGROUND OF THE INVENTION

The present invention relates to an apparatus and method for attaching threaded inserts to a workpiece, the workpiece having a first side and a second side. Usually, but not always, the first side is a visible side and the second side is a blind side, meaning there is no access to the second side. More particularly, this invention relates to an installation tool which is controlled by processing means such that various parameters in the installation process may be controlled, monitored, and recorded.

It is known to use threaded rivet nuts, threaded inserts, and threadable inserts (hereinafter collectively referred to as anchor devices), as anchors for threaded fasteners in a number of different applications, including thin wall applications, such as sheet metal, which may be too thin to be tapped with threads. In many such cases there is access only to one side of the workpiece. In general, the workpiece is drilled or punched and the anchor device is placed within the resulting opening. A portion of the anchor device is expanded by operation of an installation tool thereby preventing withdrawal of the anchor device from the opening. Expansion of a portion of the anchor device usually also prevents rotation of the anchor device within the opening. When the installation tool is activated, the tool acts upon a sleeve portion of the anchor device disposed on the second side of the workpiece. The sleeve portion is deformed to create an enlargement which prevents removing the insert from the hole. After the installation tool is removed, a threaded fastener may be inserted into a threaded portion of the anchor device. Alternatively, the anchor device may comprise a pre-installed threaded stud member. With this type of anchor device, the pre-installed threaded stud member may be utilized to attach a structure to the workpiece by either installing a nut on the stud member or having a threaded opening in the structure.

Installation tools for setting anchor devices, particularly in blind applications, are known. These tools generally comprise a tool body having a rotating member which is either a stud member having external threads or, alternatively, a drive member having a threaded opening. There are means within the tool body for rotating the stud member or drive member. The anchor device is attached to the installation tool by either screwing the internal threads of the anchor device onto the external threads of the stud member, or by making up an integral stud member extending from the anchor device to the threads of the female opening of the drive member. A portion of the anchor device is inserted within the opening in the workpiece such that a portion of the anchor device is disposed on the second side of the workpiece and a flange on the anchor device abuts the first side of the workpiece. It is to be appreciated that the anchor device may be attached to the installation tool either before or after insertion of the anchor device into the opening of the work piece.

Once the anchor device is disposed within the workpiece as described above, the rotating means within the tool body is activated, causing the stud member or the pre-attached stud to make up into the threads of the anchor device, thereby applying a linear force to the sleeve portion of the anchor device disposed on the second side of the workpiece. The application of linear force on the anchor device causes the sleeve of the device to plastically deform, such that the expanded portion, sometimes referred to as the “bubble”, is larger than the diameter of the opening, preventing withdrawal of the anchor device from the opening. Application of the linear force may also cause a portion of the sleeve within the opening to expand into the sides of the opening, such that rotation or movement of the sleeve within the opening is restrained.

In many applications it would be useful to monitor and control the amount of linear force applied to the anchor device, so as to control the amount of deformation of the sleeve. Such control would be useful to insure that sufficient deformation has occurred to secure the anchor device to the workpiece without causing failure of the anchor. Such control also reduces operator error in setting the anchor device. In addition, such control facilitates obtaining uniformly sized bubbles, which may enhance the appearance of the second side of the work piece.

It would also be advantageous to be able to monitor and control various parameters associated with the installation of the anchor devices. In some cases, such as the manufacture of aircraft components, it is desirable to maintain a permanent history of the manufacturing process. In some applications, it may be desirable to control the number of rotations, the degrees of rotation and/or the amount of torque required to set the anchor device and to make a record of the same for the construction history. Having such control may also facilitate quality control within a manufacturing facility, where having the ability to precisely control the setting of anchor devices reduces the potential for operator error. Additionally, the ability to remotely monitor and control the installation parameters allows for automation of the installation of anchor devices, as human tool operation is not required to ensure a engineered anchor installation.

### SUMMARY OF THE INVENTION

The present invention is directed to an installation system for anchor devices and a method which meet the needs identified above. The disclosed apparatus is a system for installing an anchor device within an aperture in a workpiece, the workpiece having a first side and a second side. The anchor device is the type in which, upon application of a linear force provided by a tool, a portion of the anchor device plastically deforms to form a bubble on the second side of the workpiece, thereby preventing withdrawal of the anchor device from the aperture. The anchor device comprises a sleeve member, which partially deforms to form the bubble, and an integral flange, where the flange has a larger diameter than the aperture. Once the bubble is formed, the workpiece is sandwiched between the integral flange on the first side and by the bubble on the second side.

The system comprises a tool body, where the tool body comprises a front end section and a motor housing at the rearward portion of the tool body. The motor housing can comprise an electrical motor having a drive shaft extending axially from the motor housing. The rotation means can also comprise a pneumatic rotation means. The front end section and the motor housing are connected with a housing adapter. The front end section comprises a nose piece. The front end section further comprises anchor device attachment means. Drive shaft extension members operationally connect the drive shaft of the motor to the anchor device attachment means, such that the anchor device attachment means are rotated by the motor. The drive shaft extension members extend axially through the housing adapter and through the front end section. The configuration and lengths of the housing adapter and the drive shaft extension members may be modified as indicated in the attached figures to control the length of the tool body. In some applications it may be desirable to have a shorter tool length. In addition, the front end section may comprise right angle drive means, which allow the installation tool to install anchor devices at an angle which is generally perpendicular to the axis of the tool body. The right angle drive means may be utilized for operator comfort, or as required by the configuration of a particular work piece or work space.

The anchor device attachment means may comprise a threaded stud which extends through the nose piece of the tool body. Alternatively, the anchor device attachment means may comprise a drive member disposed within the nose piece, wherein the drive member comprises a threaded opening which attaches to an integral threaded stud member of the anchor device. When a threaded stud is made up into the threads of the anchor device by the motor's rotation, a linear force is applied to the sleeve of the anchor device, causing the sleeve to collapse and plastically deform, thereby forming the bubble on the second side of the work piece.

The tool body comprises signal input and output means for transmitting and receiving electrical signals from processing means which monitor and control the actions of the motor. The tool body may further comprise various alarm means, such as audible alarms and/or visual indicators, such as light emitting diodes, which provide information to the tool operator, such as advising the operator that the desired torque has been reached.

The front end section may comprise quick release means for connecting the front end section to the housing adapter. Acceptable front sections are manufactured by AVK, which are known to be used with air operated power tools for installing anchor devices. Acceptable motor housings, which include the signal input and output means, are manufactured by ATLAS COPCO, and include motor housings utilized for the TENSOR DL, TENSOR SL, TENSOR DS, TENSOR S and TENSOR ST power tools. These tools digitally communicate with a controller unit. Except for the TENSOR DS, these tools utilize strain gauge transducers to determine the observed torque. The TENSOR DS has no transducer, but instead derives torque from various relevant parameters, such as voltage, speed, temperature and current. The ATLAS COPCO tools are generally utilized as nutrunners and it is not known to use these or similar tools for the setting of anchor devices as those described herein. The combination of a front section utilized for anchor devices with a processing means which control, monitor and/or record various installation parameters, such as torque, is not known in the art and comprises a novel feature of the disclosed apparatus and method.

The installation system further comprises processing means which are adapted to transmit and receive electrical signals from the rotation means. Acceptable processing means comprise the POWER FOCUS 3100 controller manufactured by ATLAS COPCO, or similar controllers. The processing means may be connected into a system network which allows multiple installation devices to be monitored and controlled, such that the installation tools for an entire installation facility may be controlled, monitored, or recorded by a centralized processor networked with a plurality of controllers.

### BRIEF DESCRIPTION OF THE DRAWINGS

FIG. 1 shows an assembled view of an embodiment of a portion of a tool body, showing how an embodiment of a front end section may be attached to a motor housing using the combination of a housing adapter and shaft adapter.

FIG. 2 shows an exploded view of the embodiment of the portion of the tool body shown in FIG. 1.

FIG. 3 shows an assembled view of a portion of another embodiment of a tool body, showing how an embodiment of a front end section may be attached to a motor housing using the combination of a housing adapter and shaft adapter. It is to be appreciated that the embodiment shown in this figure provides for an overall reduction in tool body length from the embodiment shown in FIG. 1.

FIG. 4 shows a cross sectional view of the embodiment of the housing adapter shown in FIG. 3.

FIG. 5 shows a perspective view of an embodiment of a housing adapter.

FIG. 6 shows a side view of the embodiment of the housing adapter shown in FIG. 5.

FIG. 7 shows a cross sectional view of the housing adapter, taken essentially along the lines 7-7 of FIG. 6.

FIG. 8 shows a left side view of the housing adapter, as seen based upon FIG. 6.

FIG. 9 shows a right side view of the housing adapter, as seen based upon FIG. 6.

FIG. 10 shows a side view of an embodiment of a shaft adapter which may be utilized with the housing adapter of FIG. 5.

FIG. 11 shows a cross sectional view of the shaft adapter of FIG. 10, taken essentially along the lines 11-11 of FIG. 10.

FIG. 12 shows an embodiment of the components of the anchor device installation system and shows the tool body, the front end section, the motor housing, alarm means, activation means, nose piece, anchor attachment means, processing means and connecting conductor.

FIG. 13 shows a side view of an embodiment of a drive shaft which may be utilized for the embodiment of the tool body shown in FIG. 3 for coupling the motor housing of an ATLAS COPCO TENSOR ST power tool to the front end section depicted in FIG. 3 to achieve a reduction in overall tool body length.

FIG. 14 is a perspective view of the drive shaft of FIG. 13.

FIG. 15 is a perspective view of an embodiment of a drive shaft extension member which may be utilized in combination with the drive shaft shown in FIG. 13 for coupling the motor housing of an ATLAS COPCO TENSOR ST power tool to the front end section depicted in FIG. 3 to achieve a reduction in overall tool body length.

FIG. 16 is a side view of the embodiment of the drive shaft extension member shown in FIG. 15.

FIG. 17 is a cross section of the embodiment of the drive shaft extension member shown in FIG. 16, taken essentially along the lines 17-17 of FIG. 16.

FIG. 18 is a left side view of the drive shaft extension member shown in FIG. 16.

FIG. 19 is a right side view of the drive shaft extension member shown in FIG. 16.

### DETAILED DESCRIPTION

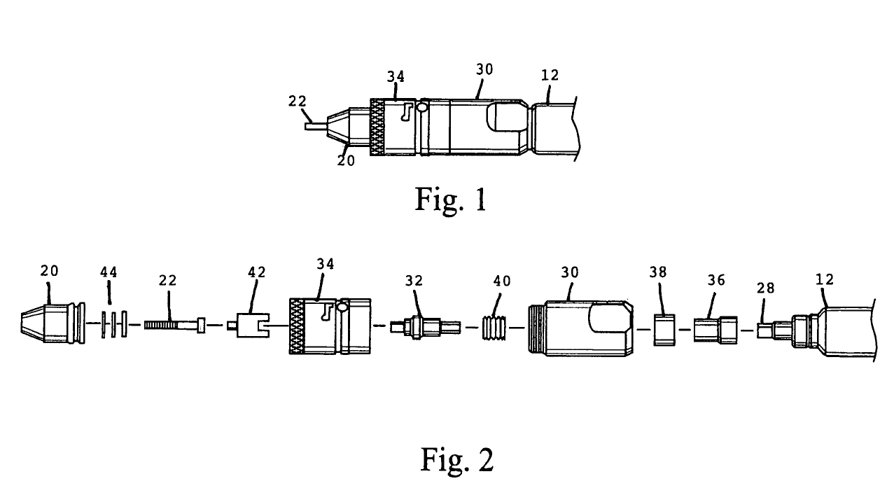

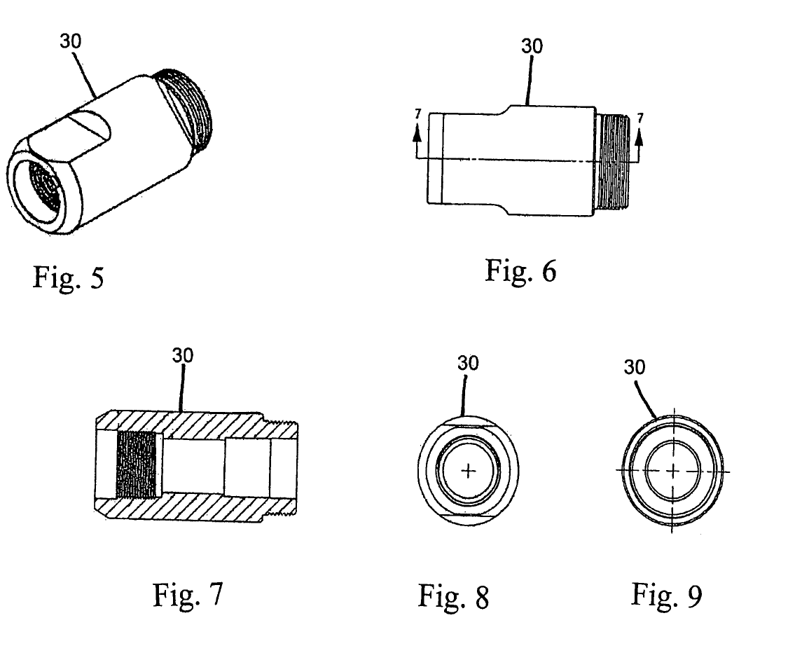

As shown in the Figures, the disclosed installation system will be described. In FIG. 1 a partial view of the installation system is shown. Shown is an assembled view of the front end section 12, an embodiment of the housing adapter 30, the quick release connector 34, the nose piece 20 and an embodiment of the anchor device attachment means 22 used to install an anchor device. The embodiment of the housing adapter 30 is shown in FIGS. 5 through 9 in more detail. FIG. 2 shows an exploded view of FIG. 1. The drive shaft 28 which extends axially forward from the front end section 12 engages a shaft adapter 36 which is then engaged by a bearing 38. The drive shaft 28, shaft adapter 36, and bearing 38 are disposed within the embodiment of the housing adapter 30 on the front end section 12 side of the embodiment of the housing adapter 30. The nose piece 20 side of the embodiment of the housing adapter 30 contains a spring 40 which engages the drive shaft extension member 32. A quick release connector 34 is shown and the drive shaft extension member 32 extends through the quick release connector 34 and engages a hex drive 42 which engages the attachment means 22. The attachment means 22 extends through a bearing set 44 and extends from the nose piece 20. When the installation system is operated, the rotation is transmitted from the drive shaft 28 to the shaft adapter 36 to the drive shaft extension member 32 to the hex drive 42 and then to the attachment means 22, and the anchor device is installed.

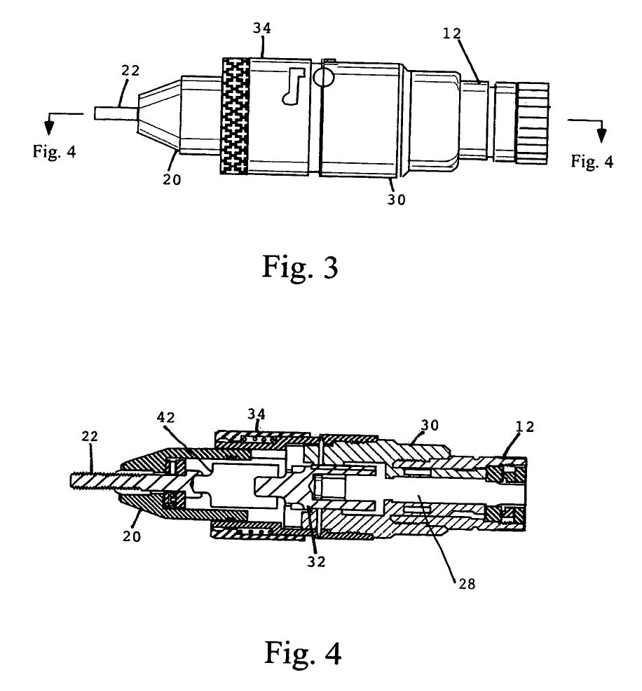

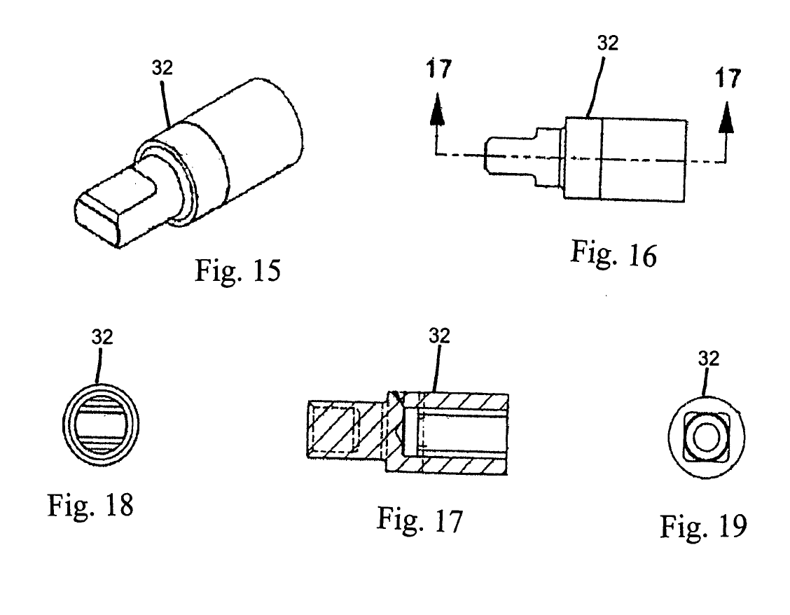

FIGS. 3 and 4 show an alternate embodiment of the housing adapter 30, and this embodiment of the housing adapter 30 allows for a decreased overall length for the installation system. Shown in FIG. 3 is an assembled view of the front of the tool and shows the front end section 12, an embodiment of the housing adapter 30, the quick release connector 34, the nose piece 20 and an embodiment of the anchor device attachment means 22 used to install an anchor device. With reference to FIG. 4, the components shown in exploded view in FIG. 2 may be seen assembled in the cross sectional view. The front end section 12 and the drive shaft 28 can be seen as the embodiment of the housing adapter 30 is threadedly engaged onto the front end section 12. The embodiment of the housing adapter 30 is threadedly engaged to the quick release connector 34, and the nose piece 20 is engaged by the quick release connector 34. The drive shaft extension member 32 engages the hex drive 42, and the hex drive 42 engages the attachment means 22. The drive shaft extension member 32 used in this embodiment is shown in FIGS. 15 through 19.

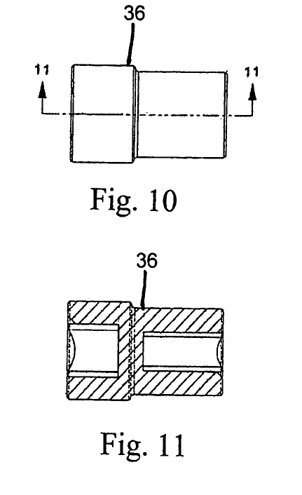

FIGS. 10 and 11 show an embodiment of the shaft adapter 36 that may be used with the embodiment of the housing adapter 30 shown in FIGS. 5 through 9. The shaft adapter 36 engages the drive shaft to transmit the rotation when the system is engaged.

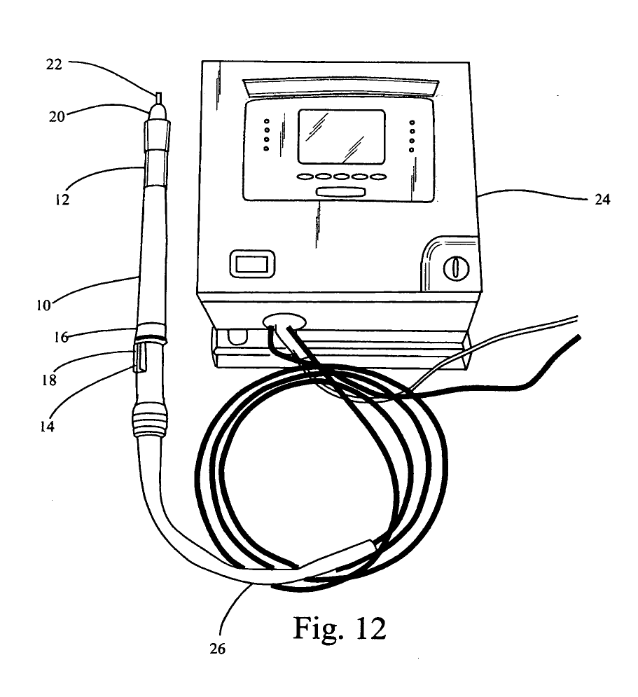

With reference to FIG. 12, the tool body is designated by the numeral 10. The digital processing means 24 monitors and controls the tool operation, and the installation system may be utilized in an automated assembly facility, as the digital processing means 24 can initiate the installation of the anchor device, monitor and record the installation parameters, and cease rotation at the preset installation parameter. The monitored and controlled installation parameters may include number of rotations, the degrees of rotation, the amount of torque, or a combination of these parameters. The connection cable 26 transmits and receives electrical signals from the digital processing means 24 to the tool body 10. The tool 10 comprises a motor housing 14, and the motor housing 14 can comprise an electrical motor, although a pneumatic source may also provide the rotation means. The pneumatic rotation means can be coupled with the digital processing means 24 to monitor the installation parameters. The alarm means 16 may comprise visual or audible alarms. These alarms 16 can signal requirements for tool maintenance, an indication that the preset torque has been achieved, or the angle of insertion of the anchor device, among other parameters that are monitored and can be recorded. The visual alarms may comprise light emitting diodes, and various colors or flash sequences may indicate the various monitored conditions. The anchor attachment means 22 and the nose piece 20 are connected to the front end 12 and transmit the rotations to install the anchor device when the activation means 18 is engaged. Activation means 18 may comprise a trigger attached to the tool body 10, such that manipulation of the trigger activates and deactivates an electrical contact and establishes electrical signal engagement with the digital processing means 24.

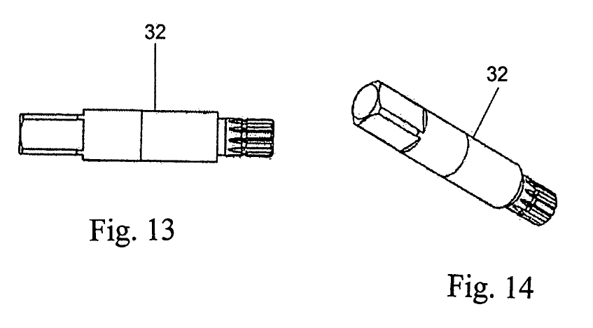

FIGS. 13 and 14 show an embodiment of the drive shaft extension member 32 that may be used with the housing adapter 30 shown in FIGS. 5 through 9 and the shaft adapter 36 of FIGS. 10 and 11. The drive shaft extension member 32 coupled with the shaft adapter 36 provides for a reduced length of the housing adapter 30, and therefore a reduced overall tool length.

FIGS. 15 through 19 show an embodiment of the drive shaft extension member 32 that may be utilized with the embodiment of the housing adapter 30 shown in FIGS. 1 and 2.

The method of installing an anchor device comprises installing an anchor device within an aperture in a workpiece, where the workpiece has first and second sides. The anchor device being the type of anchoring device in which a portion of the anchor device plastically deforms on the second side of the workpiece upon application of a linear force upon the anchor device. The method comprises the steps of attaching the anchor device to an installation tool, wherein the installation tool has digital input and output means in communication with a digital processor that has been programmed with one or more desired anchor device installation parameters, activating the activation means thereby activating the rotation means such that the rotation means rotates the anchor device attachment means until the desired anchor device installation parameter is achieved.

The installation tool comprises a front end section comprising anchor device attachment means. There are rotation means attached to the anchor device attachment means, and the rotation means can be activated by activation means. The installation tool further comprises a motor housing comprising digital input and output means, and the digital input and output means are in communication with a digital processor. The digital processor can be configured to be programmed with one or more desired anchor device installation parameters. Upon activating the rotation means, the rotation means rotates the anchor device attachment means until the desired anchor device installation parameter is achieved. The method may monitor and record as the desired anchor device installation parameter the torque applied to the anchor device.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed.

What is claimed is:

1. An installation system for installing an anchor device within an aperture in a workpiece, the workpiece having a first side and a second side, the anchor device being of the type in which a portion of the anchor device plastically deforms on the second side of the workpiece upon application of a linear force, the installation system comprising:
a tool body;
a nose piece attached to the tool body;
an attachment means for removable attachment to the anchor device, the attachment means extending from the nose piece;
rotation means contained within the tool body connected to the attachment means;
a digital processing means adapted to transmit and receive electrical signals from the rotation means; and
activation means for activating the rotation means and the digital processing means.

2. The installation system of claim 1 wherein the tool body comprises a front end section and a motor housing at the rearward portion of the tool body.

3. The installation system of claim 2 wherein the motor housing comprises an electrical motor having a drive shaft extending axially forward from the motor housing.

4. The installation system of claim 3 wherein the front end section and the motor housing are connected with a housing adapter.

5. The installation system of claim 4 wherein a drive shaft extension member operationally connects the drive shaft of the electrical motor to the attachment means, such that the anchor device attachment means are rotated by the electrical motor.

6. The installation system of claim 5 wherein the anchor device attachment means comprise a threaded stud.

7. The installation system of claim 5 wherein the anchor device attachment means comprises a female drive member having a threaded opening.

8. The installation system of claim 1 wherein the activation means comprises a trigger attached to the tool body, the trigger comprising an electrical contact which is activated upon manipulation of the trigger.

9. The apparatus of claim 2 wherein the motor housing comprises alarm means.

10. The apparatus of claim 9 wherein the alarm means comprise audible alarms.

11. The apparatus of claim 9 wherein the alarm means comprise visual alarms.

12. The apparatus of claim 11 wherein the visual alarms comprise light emitting diodes.

13. An apparatus for installing an anchor device within an aperture in a workpiece, the workpiece having a first side and a second side, the anchor device being of the type in which a portion of the anchor device plastically deforms on the second side of the workpiece upon application of a linear force to the anchor device, the apparatus comprising:
a front section comprising a nose piece having an opening there-through and a drive member partially extending through the opening, the drive member comprising anchor device attachment means;
a quick release connector having a forward end and a rearward end, the forward end attached to the front section;
a housing adapter attached to the rearward end of the quick release connector;
a motor housing having a front end and a back end, a drive shaft extending from the front end, the front end attached to the housing adapter, the motor housing comprising digital input and output means, the digital input and output means in communication with a digital processor; and
linkage means connecting the drive shaft to the drive member.

14. The apparatus of claim 13 wherein the linkage means comprises, in relative position extending from the drive shaft to the drive member, a shaft adapter, a square adapter, and a hex drive.

15. The apparatus of claim 13 wherein the motor housing comprises alarm means.

16. The apparatus of claim 15 wherein the alarm means comprise audible alarms.

17. The apparatus of claim 15 wherein the alarm means comprise visual alarms.

18. The apparatus of claim 17 wherein the visual alarms comprise light emitting diodes.

19. A method of installing an anchor device within an aperture in a workpiece, the workpiece having a first side and a second side, the anchor device being of the type in which a portion of the anchor device plastically deforns on the second side of the workpiece upon application of a linear force, the method comprising the steps of:
attaching the anchor device to an installation tool, the installation tool comprising a front end section comprising anchor device attachment means, rotation means attached to the anchor device attachment means, the rotation means activated by activation means, the installation tool further comprising a motor housing comprising digital input and output means, the digital input and output means in communication with a digital processor, the digital processor configured to be programmed with one or more desired anchor device installation parameters;
programming the digital processor to a desired anchor device installation parameter; and
activating the rotation means such that the rotation means rotates the anchor device attachment means until the desired anchor device installation parameter is achieved.

20. The method of claim 19 wherein the desired anchor device installation parameter is torque applied to the anchor device.
